(19) United States
(12) Patent Application Publication
(10) Pub. No.: US 2026/0126346 A1
(43) Pub. Date: May 7, 2026

(54) METHOD FOR RAPID BEARING DAMAGE ANALYSIS

(71) Applicant: National Formosa University, Huwei Township (TW)

(72) Inventors: Jenn-Kai Tsai, Huwei Township (TW); Chiu-Chang Chen, Huwei Township (TW)

(21) Appl. No.: 19/363,716

(22) Filed: Oct. 21, 2025

(30) Foreign Application Priority Data
Nov. 1, 2024 (TW) 113141984

(51) Int. Cl. G01M 13/045; G06F 17/14

(52) U.S. Cl. CPC G01M 13/045; G06F 17/142

(57) ABSTRACT

A method for rapid bearing damage analysis, including the following steps: training model data with an algorithm to generate a modal information model, including obtaining a vibration signal from a test bearing, converting the signal into a vibration spectrum, smoothing, visualizing, and annotating the vibration spectrum with modal information, then doing image recognition training on the vibration spectrum as the model data using the algorithm. Thereafter, loading the modal information model to recognize modal information of a bearing and perform damage analysis to generate a diagnostic result. This process includes obtaining the bearing's vibration signal, converting it into a vibration spectrum, smoothing the spectrum, recognizing the modal information using the modal information model, performing band-pass filtering based on the modal information, and performing demodulation to obtain a characteristic frequency, ultimately producing the diagnostic result.

### FIELD OF INVENTION

The present invention relates to a method for bearing damage analysis, and more particularly to a method for rapid bearing damage analysis.

### BACKGROUND OF THE INVENTION

Bearings are indispensable and critical components in modern mechanical equipment. Whether in household appliances used in daily life or in large-scale machinery such as industrial equipment, automobiles, and aircraft, bearings play a vital role in supporting rotational motion, reducing friction, and enhancing operational efficiency. The proper functioning of bearings is directly related to the performance and safety of mechanical equipment. Therefore, accurately and promptly detecting and analyzing bearing damage is of the utmost importance.

Among existing techniques, vibration analysis is the most commonly used method for detecting and diagnosing bearing damage, widely applied in condition monitoring (CM) of industrial equipment. This method measures vibration signals during operation using accelerometers installed near the bearing, and transforms these signals into vibration modes to identify potential damage issues. However, conventional vibration analysis methods require skilled technicians to perform data analysis and interpretation. The process is time-consuming, and identification of vibration modes must be conducted under specific rotational speeds and conditions, making full automation difficult to achieve. As a result, operational and labor costs increase significantly, and the equipment needs to be shut down during inspection, leading to a loss in production efficiency.

Therefore, the development of a rapid and automated technology for bearing damage analysis and detection has become an urgent objective in the related field.

### SUMMARY OF THE INVENTION

To develop a fast and automated bearing fault analysis and detection technology, the present invention provides a method for rapid bearing damage analysis, comprising steps of: training model data with an algorithm to generate a modal information model, comprising: obtaining a vibration signal of a test bearing; converting the vibration signal into a vibration spectrum; smoothing and visualization the vibration spectrum, and annotating the vibration spectrum with modal information; and performing image recognition training on the model data using the vibration spectrum with the algorithm; and loading the modal information model to recognize the modal information of a bearing and perform bearing damage analysis to generate a diagnostic result, comprising: obtaining the vibration signal of the bearing and converting the vibration signal into the vibration spectrum; smoothing the vibration spectrum and recognizing the modal information using the modal information model; performing band-pass filtering on the vibration signal and the vibration spectrum based on the modal information; and performing demodulation to obtain a characteristic frequency and generating the diagnostic result.

Wherein, the algorithm is a one-stage object detection algorithm.

Wherein, the algorithm is YOLO.

Wherein, the demodulation is performed using a method employing a cumulative enhanced energy operator to demodulate the modal signal.

Wherein, the method of the cumulative enhanced energy operator defines the vibration signal as a function s(t), where t=n represents each sampling time point of the vibration signal, and the cumulative enhanced energy operator function CEEO(s(n)) is defined as CEEO(s(n))=s²(n)−s(n−2)s(n+2).

Wherein, smoothing the vibration spectrum comprising using methods of simple moving average, weighted moving average, exponential moving average, Savitzky-Golay filtering, locally weighted regression, or wavelet smoothing.

Wherein, smoothing the vibration spectrum uses the method of simple moving average.

Wherein, the modal information comprises one or more modal signals and one or more corresponding modal positions, and the band-pass filtering retains the modal signals at the modal positions of the vibration spectrum in accordance with the modal information model.

Wherein, the modal position corresponds to a bounding box of the model data.

Wherein, the method of converting the vibration signal into the vibration spectrum is Fast Fourier Transform.

Based on the above description, it is clear that the present invention achieves the following advantages:

1. The method for rapid bearing damage analysis in accordance with the present invention can be highly automated, eliminating the need for extensive operation by specialized technicians and complex data analysis and interpretation. This significantly simplifies damage analysis, reduces labor costs, and improves analysis efficiency.

2. The method for rapid bearing damage analysis in accordance with the present invention significantly reduces the time required for damage analysis compared to prior arts, enabling real-time damage detection and monitoring, thereby greatly improving production efficiency and minimizing downtime.

3. The rapid bearing damage analysis method in accordance with the present invention does not require operating at specific rotational speeds and environmental conditions to obtain vibration modes as in traditional bearing damage analysis. Instead, damage analysis can be performed directly during the operation of the bearings without the need to stop the machine or adjust to designated speeds, thereby enhancing the convenience of damage analysis.

4. The method for rapid bearing damage analysis in accordance with the present invention is not only highly efficient but also requires minimal computational power. It can be applied in environments with limited resources, such as microprocessors or portable devices, significantly optimizing computational efficiency. This enables microprocessors to perform reliable bearing damage prediction and detection at lower power consumption, greatly reducing implementation costs and allowing for widespread application.

### BRIEF DESCRIPTION OF THE DRAWINGS

FIG. 1 is a schematic flowchart illustrating steps of a preferred embodiment in accordance with the present invention;

FIG. 2 is a schematic flowchart illustrating steps of training a model of a preferred embodiment in accordance with the present invention;

FIG. 3 is a schematic flowchart illustrating steps of loading a modal information model of a preferred embodiment in accordance with the present invention;

FIG. 4 is a schematic diagram of a vibration signal of an embodiment in accordance with the present invention;

FIG. 5A is a schematic diagram of a vibration spectrum of one embodiment in accordance with the present invention;

FIG. 5B is a schematic diagram showing a vibration signal after smoothing processing of an embodiment in accordance with the present invention;

FIG. 5C is a schematic diagram showing the result after band-pass filtering process of an embodiment in accordance with the present invention;

FIG. 5D is a schematic diagram showing the result after demodulation of an embodiment in accordance with the present invention;

FIG. 6A is a schematic diagram of a vibration spectrum of another embodiment in accordance with the present invention;

FIG. 6B is a schematic diagram showing a vibration signal after smoothing processing of another embodiment in accordance with the present invention;

FIG. 6C is a schematic diagram showing the result after band-pass filtering process of another embodiment in accordance with the present invention;

FIG. 6D is a schematic diagram showing the result after demodulation of a normal bearing in another embodiment of the present invention.

### DETAILED DESCRIPTION OF THE PREFERRED EMBODIMENTS

To more clearly illustrate the technical solutions of the embodiments of the present invention, brief introductions to the drawings used in the following descriptions of the embodiments are provided below. It is apparent that the drawings described below are merely some examples or embodiments of the present invention. Those of ordinary skill in the art may, without creative effort, apply the present invention to other similar situations based on these drawings. Unless clearly indicated otherwise by the context or separately specified, identical reference numerals in the drawings denote identical structures or operations.

As used in the present invention and the claims, unless the context clearly indicates otherwise, terms such as “a,” “an,” “one,” or “the” are not limited to the singular and may also encompass the plural. In general, the terms “comprise” and “include” indicate the inclusion of the stated steps or elements but do not exclude the presence of other steps or elements not expressly listed.

Flowcharts are used in the present invention to illustrate operations performed by a system according to embodiments of the invention. It should be understood that the preceding or subsequent operations are not necessarily executed in the exact order described. On the contrary, steps may be executed in reverse order or concurrently. Additionally, other operations may be added to these processes, or one or more steps may be removed from these processes.

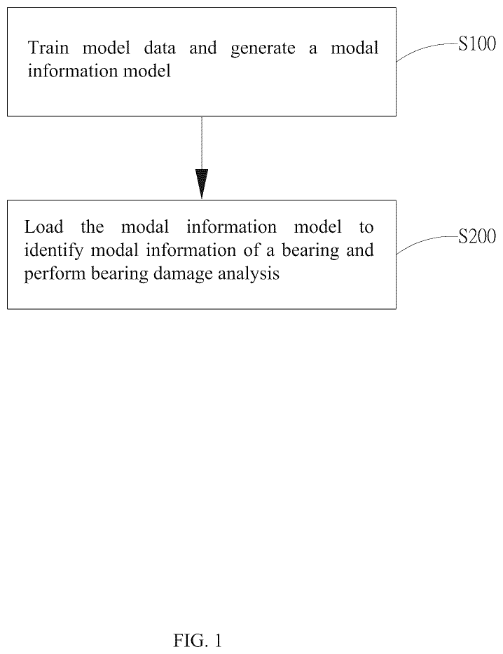

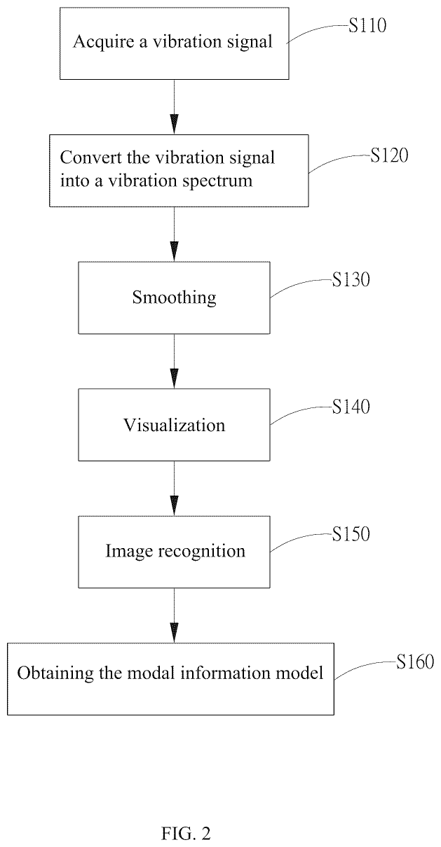

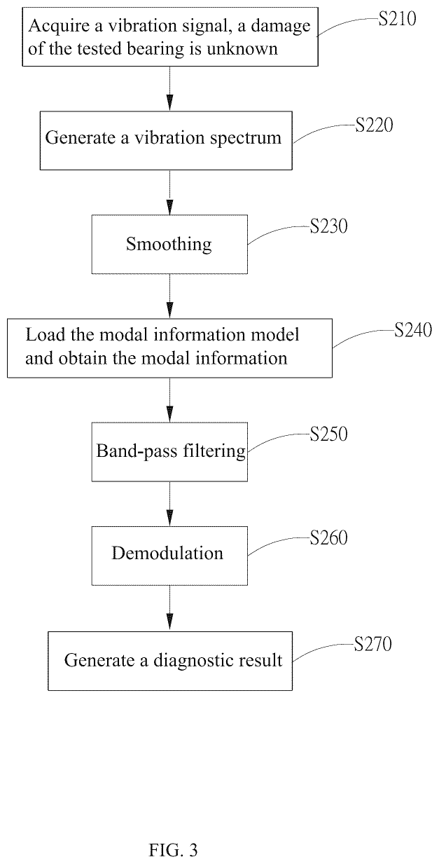

With reference to FIGS. 1 to 3, steps of a preferred embodiment of a method for rapid bearing damage analysis in accordance with the present invention are illustrated. The method of the present invention can be mainly divided into the following two parts:

Step S100: Load an algorithm to train model data and generate a modal information model; and

Step S200: Load the modal information model to identify modal information of a bearing and perform bearing damage analysis to generate a diagnostic result.

The first part, Step S100, involves training the model data using the algorithm to generate the modal information model capable of rapidly analyzing the modal information of the bearing. The second part, Step S200, involves using the obtained modal information model to acquire the modal information of the bearing and rapidly perform bearing damage analysis to generate the diagnostic result. The detailed steps of Step S100 are as follows:

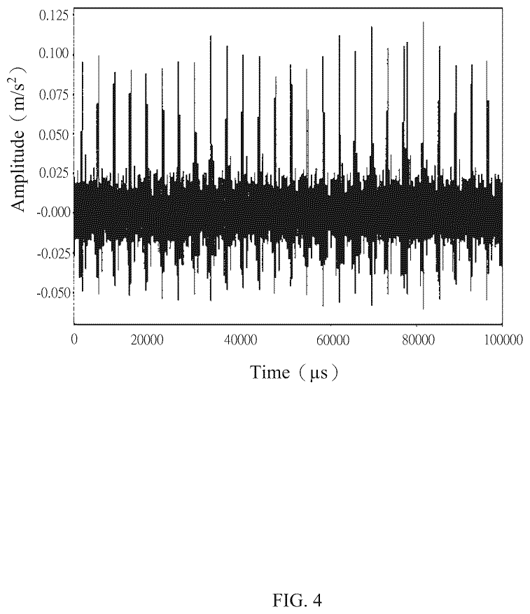

Step S110: Acquire a vibration signal. With reference to FIG. 4, in Step S110, an accelerometer is used measured a test bearing mounted on a rotating shaft of a machine, to obtain a vibration signal resulting from the resonance between the bearing and the machine. Preferably, in Step S110, the damage condition of the test bearing is known.

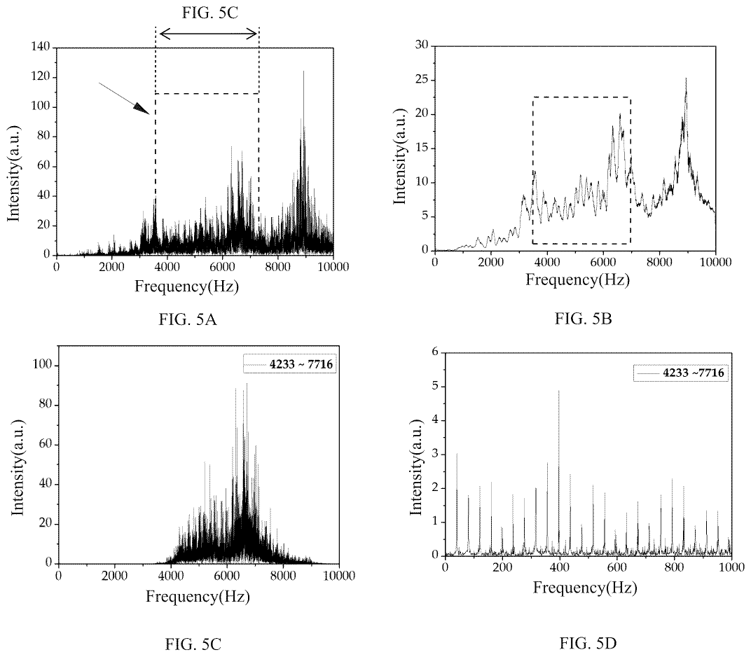

Step S120: Convert the vibration signal into a vibration spectrum. With reference to FIG. 5A, in Step S120, the vibration signal is transformed from the time domain to the frequency domain to generate the vibration spectrum. Preferably, the conversion method used is Fast Fourier Transform (FFT). After converting the vibration signal into the vibration spectrum, due to the influence of environment, the machine and the rotating shaft, the graph of the vibration spectrum is complex containing multiple significant energy peaks and multiple non-modal energy peaks (as shown by the arrows in FIG. 5A) Also, due to the superposition of machine resonance harmonics, the graph of the vibration spectrum contained the multiple non-modal energy peaks. The multiple non-modal energy peaks may affect machine to recognize the multiple significant energy peaks, and even lead to wrong judgment.

Step S130: Smoothing. With reference to FIG. 5B, in Step S130, the vibration spectrum is smoothed to improve recognition accuracy. The smoothing may include methods such as simple moving average (SMA), weighted moving average (WMA), exponential moving average (EMA), Savitzky-Golay filtering, locally weighted regression, wavelet smoothing, and the like.

In existing techniques, the identification of the bearing damage still relies on manual identification due to the vibration spectrum graph containing both multiple significant energy peaks and multiple non-modal energy peaks. These non-modal peaks cause interference that prevents the machine from accurately recognizing the significant energy peaks associated with bearing damage. Smoothing can effectively reduce the multiple non-modal energy peaks, thereby improving the accuracy of automatic bearing damage identification.

Preferably, in this embodiment, the smoothing is performed using the simple moving average (SMA) method. The SMA method calculates the average energy within a fixed frequency range to effectively smooth out the significant energy peaks while preserving the vibration spectrum pattern. Wherein, appropriately setting the fixed frequency range can preserve characteristics of the modal information and improve recognition successfully, as expressed by the following formula:

$$S M A = \frac{{C}_{1} + {C}_{2} + {C}_{3} + {C}_{4} + {C}_{5} + ⋯ {C}_{n}}{n}$$

Wherein, (represents the energy values at different frequencies, and n represents the total number of frequencies in the processed spectrum pattern.

Step S140: Visualization. In Step S140, the smoothed vibration spectrum is visualized to form a vibration spectrum image, and the modal information is annotated on the vibration spectrum image.

Step S150: Image Recognition. Prior to Step S150, Steps S110 through S140 are repeated to obtain multiple of the vibration spectrum images. The vibration spectrum images are used by the algorithm to perform image recognition training on the model data. Preferably, the algorithm is a one-stage object detection algorithm. More preferably, the algorithm is YOLO (You Only Look Once), especially the latest version of YOLO. Preferably, the model data comprising multiple vibration spectrum images are divided into a training set and a testing set. More preferably, the model data is divided into a training set, a validation set, and a testing set. In a preferred embodiment, 80% of the model data is used as the training set.

Step S160: Obtaining the Modal Information Model. In Step S160, through the image recognition training performed on the vibration spectrum images in Step S150, the modal information model is obtained, completing the training of the model for image recognition. The modal information includes one or more modal signals and one or more corresponding modal locations. The modal locations correspond to bounding boxes of the modal information.

After the modal information model is established, bearing damage analysis can be performed on any arbitrary bearing.

The detailed steps of Step S200 are as follows:

Step S210: Acquire the vibration signal, a damage of the tested bearing is unknown. The accelerometer measures the tested bearing to be diagnosed to obtain the vibration signal. In this embodiment, the present invention also uses FIG. 4 as the vibration signal of the tested bearing with damage. The vibration characteristics of the vibration signals is different between the tested bearings or each measurement of the tested bearing due to a rotation speed, a measurement environment, or a position of the each tested bearing relative to a rotating device.

Step S220: Generate the vibration spectrum. With reference to FIG. 5A, in Step S220, the vibration signal is transformed from the time domain to the frequency domain to generate the vibration spectrum. Preferably, the conversion method used is Fast Fourier Transform (FFT).

Step S230: Smoothing. With reference to FIG. 5B, in Step S230, the vibration spectrum is smoothed. The smoothing may include methods such as simple moving average, weighted moving average, exponential moving average, Savitzky-Golay filtering, locally weighted regression, wavelet smoothing, and the like. Preferably, the smoothing is performed using the simple moving average method.

Step S240: Load the modal information model and obtain the modal information. In Step S240, the modal information model trained in Step S100 is used to recognize the smoothed vibration spectrum and obtain the modal information of the vibration spectrum.

Step S250: Band-pass filtering. In Step S250, after obtaining the modal information, the vibration signal and the vibration spectrum undergo band-pass filtering. The band-pass filtering retains the modal signals at the modal locations of the vibration spectrum according to the modal information model. Through the band-pass filtering process of Step S250, the data processing volume can be significantly reduced allowing the system to focus on the key modal signals. This reduces computation time and filters out irrelevant signals, enabling accurate extraction of key modal signals related to the bearing faults.

Step S260: Demodulation. With reference to FIG. 5C, in Step S260, the modal signal at the modal location undergoes demodulation. The demodulated vibration signal is then transformed from the time domain to the frequency domain to obtain one or more characteristic frequency positions related to the bearing fault. Through the band-pass filtering in step S250, the section of the vibration spectrum corresponding to the selected range is identified. In this embodiment, the frequency band of 4233 Hz-7716 Hz shown in FIG. 5A is extracted, which corresponds to the dashed box area in FIG. 5B. FIG. 5C shows the result after extracting the frequency band from FIG. 5A. Preferably, the demodulation uses a method employing a Cumulative Enhanced Energy Operator (CEEO) to demodulate the modal signal.

The method using the Cumulative Enhanced Energy Operator involves analyzing an energy characteristic of the vibration signal with an energy operator.

The vibration signal after band-pass filtering in Step S250 is represented by a function s(t), where t=n denotes each sampling time point of the vibration signal.

Perform a first-order differentiation on the vibration signal to enhance high-frequency components and improve the signal-to-interference ratio (SIR), as expressed by the following formula:

$$D ( s ( t ) ) = s ( n ) - s ( n - 1 )$$

Subsequently, integrate the differentiated vibration signal to enhance the signal-to-noise ratio (SNR), as expressed by the following formula:

$$I ( s ( t ) ) = s ( n ) + s ( n - 1 )$$

Define a layer operator (LO), which combines the aforementioned differentiation and integration operations to leverage the advantages of both. Accordingly, the function of the vibration signal is operated by the first-order layer operator (LO₁) as follows:

$$L {O}_{1} ( s ( n ) ) = s ( n ) - s ( n - 2 )$$

By repeatedly applying the layer operator, the second-order layer operator (LO₂) can be obtained as follows:

$$L {O}_{2} ( s ( n ) ) = s ( n ) - 2 s ( n - 2 ) + s ( n - 4 )$$

By applying the concept of the energy operator as defined below:

$$ψ ( s ( t ) ) = {( \frac{d}{dt} s ( t ) )}^{2} - s ( t ) \frac{{d}^{2}}{{dt}^{2}} s ( t )$$

Using the same structure, by substituting the layer operator into the first-order and second-order derivatives of the energy operator, a function of the Cumulative Enhanced Energy Operator (CEEO) can be obtained as follows:

$$C E E O ( s ( n ) ) = {s}^{2} ( n ) - s ( n - 2 ) s ( n + 2 )$$

The above describes the method of the Cumulative Enhanced Energy Operator (CEEO). After the computation is completed, the demodulated vibration signal is further transformed from the time domain to the frequency domain to obtain the characteristic frequency of the bearing.

Step S270: Generate the diagnostic result. With reference to FIG. 5D, in Step S270, the diagnostic result is generated based on the positions of the characteristic frequencies obtained in Step S260. Preferably, the characteristic frequency formulas for each component of the bearing are as follows:

The characteristic frequency of multiple rolling elements fᵣₒₗₗ is

$${f}_{roll} = \frac{D}{d} {f}_{rpm} [ 1 - {( \frac{d}{D} )}^{2} {cos}^{2} φ ] ;$$

The characteristic frequency of an inner ring

$${f}_{in} is {f}_{in} = \frac{N}{2} {f}_{rpm} ( 1 + \frac{d}{D} cos φ ) ;$$

The characteristic frequency of an outer ring

$${f}_{out} is {f}_{out} = \frac{N}{2} {f}_{rpm} ( 1 - \frac{d}{D} cos φ ) ;$$

The characteristic frequency of a cage (retainer)

$${f}_{cage} is {f}_{cage} = \frac{{f}_{rpm}}{2} ( 1 - \frac{d}{D} cos φ ) ;$$

Wherein:
fᵣₚₘ is the rotational frequency of the bearing;
D is the pitch circle diameter of the bearing;
N is the number of rolling elements in the bearing;
d is the diameter of the rolling element in the bearing; and
φ is the contact angle of the rolling element in the bearing.

In one embodiment, the characteristic frequencies of the various bearing components at different rotational speeds are shown in TABLE 1. In this embodiment, the diagnostic result can be generated by comparing the obtained characteristic frequencies with the formulas. Furthermore, TABLE 1 can be used as a reference of the characteristic frequency of the bearing.

TABLE 1

| Rotational | Inner ring | Outer ring | Rolling element | |
|---|---|---|---|---|
| speed | damage | damage | damage | Cage damage |
| 800 rpm | 131.7 (Hz) | 94.9 (Hz) | 77.9 (Hz) | 5.59 (Hz) |
| 1600 rpm | 263.5 (Hz) | 189.9 (Hz) | 155.7 (Hz) | 11.2 (Hz) |
| 2400 rpm | 395.2 (Hz) | 284.8 (Hz) | 233.6 (Hz) | 16.8 (Hz) |

With reference to FIG. 5D, in this embodiment, the frequency spectrum of the bearing at rotational speed of 2400 rpm exhibits the characteristic frequency around 300 Hz. Comparing the characteristic frequencies in TABLE 1, the characteristic frequency of the various bearing components at 2400 rpm rotational speeds correspond to the damage with outer ring.

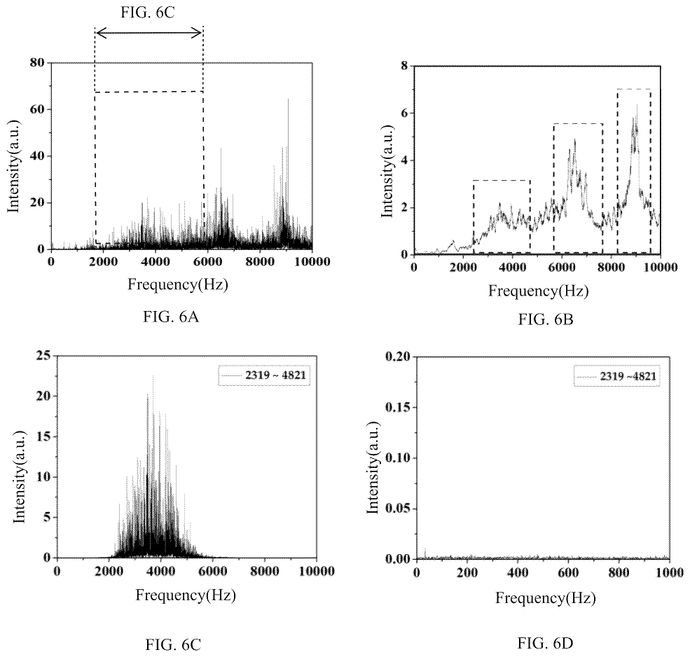

Referring to FIG. 6A-6D, in this embodiment, the present invention indicated the vibration signal of the tested bearing without damage. When the vibration signal is obtained through Step S210, it is difficult to identify if the significant energy peaks of the damage are existed.

After the tested bearing has been processed through Steps S210 to S270 above, with reference to FIG. 6D, the bearing at rotational speed of 2400 rpm for the example, the frequency spectrum of the bearing at rotational speed of 2400 rpm after the demodulation processing does not exhibit significant characteristic peaks. This indicates that when the bearing is damaged, a significant signal intensity appears at the characteristic frequency, whereas the bearing exhibits very low spectrum intensity under normal condition.

The significant difference between FIG. 5D and FIG. 6D allows us to determine whether the bearing is operating damaged or normally based on the strength of the characteristic frequency.

In addition, by following the steps for the bearing damage analysis, the resulting graphs make it easier to identify whether damage is present. As shown in FIG. 6A to 6B, the vibration spectrum exhibits a significant difference before and after the smoothing process; FIG. 6B to 6C illustrate the section of the vibration spectrum corresponding to the specific frequency after the band-pass filtering. Furthermore, FIG. 6D shows the result of the demodulation.

Based on the above description, it is clear that the present invention achieves the following advantages:

1. The method for rapid bearing damage analysis in accordance with the present invention can be highly automated, eliminating the need for extensive operation by specialized technicians and complex data analysis and interpretation. This method enables a more practical approach to damage analysis, reduces labor costs, and improves analysis efficiency.

2. The method for rapid bearing damage analysis in accordance with the present invention significantly reduces the time required for damage analysis compared to prior arts, enabling real-time damage detection and monitoring, thereby greatly improving production efficiency and minimizing downtime.

3. The rapid bearing damage analysis method in accordance with the present invention does not require operating at specific rotational speeds and environmental conditions to obtain vibration modes as in traditional bearing damage analysis. Instead, damage analysis can be performed directly during the operation of the bearings without the need to stop the machine or adjust to designated speeds, thereby enhancing the convenience of damage analysis.

4. The method for rapid bearing damage analysis in accordance with the present invention is not only highly efficient but also requires minimal computational power. It can be applied in environments with limited resources, such as microprocessors or portable devices, significantly optimizing computational efficiency. This enables microprocessors to perform reliable bearing damage prediction and detection at lower power consumption, greatly reducing implementation costs and allowing for widespread application.

It should be noted that, based on the explanations and descriptions provided above, those skilled in the art to which the present disclosure pertains may make various modifications and alterations to the embodiments described. Therefore, the present disclosure is not limited to the specific embodiments disclosed and described above, and equivalent modifications and variations that fall within the scope of the claims of the present disclosure should also be considered as included. Moreover, although certain specific terms are used in this specification, these terms are employed solely for the purpose of description and do not impose any limitation on the invention.

What is claimed is:

1. A method for rapid bearing damage analysis, comprising steps of:
training model data with an algorithm to generate a modal information model, comprising: obtaining a vibration signal of a test bearing; converting the vibration signal into a vibration spectrum; smoothing and visualization the vibration spectrum, and annotating the vibration spectrum with modal information; and performing image recognition training on the model data using the vibration spectrum with the algorithm; and
loading the modal information model to recognize the modal information of a bearing and perform bearing damage analysis to generate a diagnostic result, comprising: obtaining the vibration signal of the bearing and converting the vibration signal into the vibration spectrum; smoothing the vibration spectrum and recognizing the modal information using the modal information model; performing band-pass filtering on the vibration signal and the vibration spectrum based on the modal information; and performing demodulation to obtain a characteristic frequency and generating the diagnostic result.

2. The method for rapid bearing damage analysis according to claim 1, wherein the algorithm is a one-stage object detection algorithm.

3. The method for rapid bearing damage analysis according to claim 2, wherein the algorithm is YOLO.

4. The method for rapid bearing damage analysis according to claim 1, wherein the demodulation is performed using a method employing a cumulative enhanced energy operator to demodulate the modal signal.

5. The method for rapid bearing damage analysis according to claim 2, wherein the demodulation is performed using a method employing a cumulative enhanced energy operator to demodulate the modal signal.

6. The method for rapid bearing damage analysis according to claim 3, wherein the demodulation is performed using a method employing a cumulative enhanced energy operator to demodulate the modal signal.

7. The method for rapid bearing damage analysis according to claim 4, wherein the method of the cumulative enhanced energy operator defines the vibration signal as a function s(t), where t=n represents each sampling time point of the vibration signal, and the cumulative enhanced energy operator function CEEO(s(n)) is defined as
$$C E E O ( s ( n ) ) = {s}^{2} ( n ) - s ( n - 2 ) s ( n + 2 ) .$$

8. The method for rapid bearing damage analysis according to claim 5, wherein the method of the cumulative enhanced energy operator defines the vibration signal as a function s(t), where t=n represents each sampling time point of the vibration signal, and the cumulative enhanced energy operator function CEEO(s(n)) is defined as
$$C E E O ( s ( n ) ) = {s}^{2} ( n ) - s ( n - 2 ) s ( n + 2 ) .$$

9. The method for rapid bearing damage analysis according to claim 6, wherein the method of the cumulative enhanced energy operator defines the vibration signal as a function s(t), where t=n represents each sampling time point of the vibration signal, and the cumulative enhanced energy operator function CEEO(s(n)) is defined as
$$C E E O ( s ( n ) ) = {s}^{2} ( n ) - s ( n - 2 ) s ( n + 2 ) .$$

10. The method for rapid bearing damage analysis according to claim 7, wherein smoothing the vibration spectrum comprising using methods of simple moving average, weighted moving average, exponential moving average, Savitzky-Golay filtering, locally weighted regression, or wavelet smoothing.

11. The method for rapid bearing damage analysis according to claim 8, wherein smoothing the vibration spectrum comprising using methods of simple moving average, weighted moving average, exponential moving average, Savitzky-Golay filtering, locally weighted regression, or wavelet smoothing.

12. The method for rapid bearing damage analysis according to claim 9, wherein smoothing the vibration spectrum comprising using methods of simple moving average, weighted moving average, exponential moving average, Savitzky-Golay filtering, locally weighted regression, or wavelet smoothing.

13. The method for rapid bearing damage analysis according to claim 10, wherein smoothing the vibration spectrum uses the method of simple moving average.

14. The method for rapid bearing damage analysis according to claim 11, wherein smoothing the vibration spectrum uses the method of simple moving average.

15. The method for rapid bearing damage analysis according to claim 12, wherein smoothing the vibration spectrum uses the method of simple moving average.

16. The method for rapid bearing damage analysis according to claim 13, wherein the modal information comprises one or more modal signals and one or more corresponding modal positions, and the band-pass filtering retains the modal signals at the modal positions of the vibration spectrum in accordance with the modal information model.

17. The method for rapid bearing damage analysis according to claim 14, wherein the modal information comprises one or more modal signals and one or more corresponding modal positions, and the band-pass filtering retains the modal signals at the modal positions of the vibration spectrum in accordance with the modal information model.

18. The method for rapid bearing damage analysis according to claim 15, wherein the modal information comprises one or more modal signals and one or more corresponding modal positions, and the band-pass filtering retains the modal signals at the modal positions of the vibration spectrum in accordance with the modal information model.

19. The method for rapid bearing damage analysis according to claim 18, wherein the modal position corresponds to a bounding box of the model data.

20. The method for rapid bearing damage analysis according to claim 19, wherein the method of converting the vibration signal into the vibration spectrum is Fast Fourier Transform.
